(19) United States
(12) Patent Application Publication
(10) Pub. No.: US 2013/0285989 A1
(43) Pub. Date: Oct. 31, 2013

(54) ARTICLE-TOUCHING AND WRITING APPARATUS

(71) Applicant: Robin Jones, Anaheim, CA (US)

(72) Inventor: Robin Jones, Anaheim, CA (US)

(21) Appl. No.: 13/457,142

(22) Filed: Apr. 26, 2012

(51) Int. Cl. G06F 3/033

(52) U.S. Cl. 345/179

(57) ABSTRACT

A compact, readily portable stylus and writing apparatus for operating any device requiring contact for inputting commands such as touch screens, small buttons, and the like. The apparatus includes a conductive body, a conductive contactor, and a retractable writing instrument. The conductive contactor is positioned to easily contact a touch screen or small buttons when the apparatus is in a stowed configuration. When the apparatus is in a stowed configuration, the apparatus can be conveniently carried in the user's wallet, pocket, or purse. When the apparatus is in its deployed configuration, user can use the retractable writing instrument apparatus for writing.

### TECHNICAL FIELD

The present disclosure relates to an article-touching and writing apparatus configured for operation of touch responsive user interfaces, and more particularly, to a novel handheld article-touching and writing apparatus that can be used to operate on touch responsive user interfaces to prevent directly and physically touching potentially contaminated surfaces such as small buttons, touch screens and the like.

### TECHNICAL BACKGROUND

Research has established that various types of harmful bacteria and viruses can survive for long periods of time on the surfaces of input mechanisms such as ATM keypads, ATM touch screens, point of sale keypads, point of sale touch screens, public keypads, public touch screens, public styluses, public pens, and the like surfaces, which are being continuously physically contacted and potentially contaminated by large numbers of people. These public input mechanisms are infrequently cleaned thereby are prone to a substantial build of easily spread and harmful bacteria. Transfer of the harmful bacteria from the hand of the user to the nose and mouth or eyes can cause serious illness. Similarly, if one's hand has a cut or abrasion, and then contacts those public input mechanism through which the harmful bacteria can penetrate and enter user's body; thus, serious repercussions can follow. It is this serious cross-contamination problem that the present invention seeks to mitigate by providing a handheld apparatus which is easy to use and to transport, and can operate these public input mechanisms having highly contaminated surfaces.

Point of sale (“POS”) terminals, self checkout machines, and other financial transaction machines provide convenient electronic payment for many products and services. For example, consumers holding cards associated with a charge, credit, debit, or loyalty accounts may pay for a purchase simply by using the card with a POS terminal located at stores, supermarkets, restaurants, and other locations where the products and services are being purchased. During the transaction, as a part of the process, the customer (card holder) may make payment selections on the terminal; and during these payment transactions, customer's signatures are often required and captured by either paper or electronically means.

Payment terminals often incorporate displays as well as input devices such as keypads and/or touch screens that allow the customer to make inputs to the terminal as necessary to complete the payment transaction. Where the terminal incorporates or connects to a touch screen (or touch pad or touch panel), that touch screen is often employed to electronically capture the signature of the card holder. Resistive and capacitive touch panels are the two most widely used touch screen technologies in POS terminals. Resistive touch panels are essentially pressure sensitive and as such require pressure from a finger or stylus in order for the touch screen to detect its use. However within capacitive touch panels, the technology works by detecting changes in the emitted near field electrostatic fields radiated from the touch screen.

### TECHNICAL SUMMARY

In view of the foregoing, it is first object of the embodiment of the present invention to provide a retractable writing instrument that can be stowed when the article is being transported and quickly and easily deployed when the apparatus is to be used to perform writing purposes

The second object of the embodiment of the present invention is to provide an apparatus which when the apparatus is in a stowed configuration, the apparatus can be conventionally transported by clipping to the interior hinge fold of a conventional type wallet pocket or purse or the like.

The third object of the embodiment of the present invention is to provide an apparatus with a writing instrument, in which the writing instrument can be quickly and conveniently moved from a stowed configuration into a deployed configuration by simply pressing upon a spring loaded operating button that is mounted in the body of the apparatus.

The fourth object of the embodiment of the present invention is to provide a article-touching and writing apparatus, which is attachable to the garment or wallet with a relatively small resilient pocket-clip which is integral with the push button cap or held in place by push button cap and an adhesive or equivalent.

The fifth object of the embodiment of the present invention is to provide a body formed from any suitable conductive material, including a non-conductive material that is plated with a electrically conductive layer, such that the user receives tactile feedback when the user manipulates the touch screen of an electronic device while holding the article-touching and writing apparatus.

In accordance with sixth object, the forward end of the conductive body and receiver end of the conductive contactor in the present invention are electrically coupled, and a frictional engagement may be sufficient to hold the conductive contactor in place, though in some cases it is preferable to add a conductive adhesive.

The seventh object of the embodiment of the present invention is to provide a conductive contactor for use in the operation of an electronic device requiring the actuation of small buttons or the entry of touch-screen commands. The conductive contactor extends from the forward end of the article-touching and writing apparatus body so that it may be conveniently used to make contact with the touch screen or buttons of the electronic device

The eighth object of the embodiment of the present invention is to provide a conductive contactor with a central opening to accommodate the deployment of the writing instrument; such a construction allows two independent functions (e.g., pen and stylus) within the same instrument.

According to the embodiment, the present invention provides an article-touching and writing apparatus, comprising a conductive body with a rear end and a body tip end, a plunger member placed within the said body at said rear end, a latch spring, mounted within said plunger member, having a camming projection, a cartridge placed within said body and underneath said plunger member; and a conductive contactor coated on said body at said body tip end for article-touching, wherein said cartridge is extended out from said body at said second end for writing when said plunger member receives a pressure.

According to the embodiment, the present invention also provides a method for providing an apparatus for article-touching and writing, comprising: providing a conductive body with a rear end and a body tip end, placing a plunger member within the said body at said rear end, mounting a latch spring with a camming projection within said plunger member, placing a cartridge within said body and underneath said plunger member, coating a conductive contactor on said body at said body tip end, extending said cartridge out from said body at said second end for writing by pressing said plunger member, and retracting said cartridge into said body and performing article-touch with said conductive contactor.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a view in perspective showing a wallet and the manner in which the article-touching and writing apparatus is positioned in the hinging fold thereof for available use.

FIG. 2 is a longitudinal sectional view through a retractable pen embodying a preferred form of the invention and illustrating the writing instrument in writing position.

FIG. 2A is a greatly enlarged, generally perspective view of the area designated in FIG. 2 as 2A.

FIG. 3 is a longitudinal sectional view through a retractable pen embodying a preferred form of the invention and illustrating the writing instrument in retracted position.

FIG. 3A is a greatly enlarged, generally perspective view of the area designated in FIG. 3 as 3A.

FIG. 4 is a view showing the separated components attaching to the forward end of the boy of the preferred embodiment of the present invention.

FIG. 5 is detailed sectional view of the conductive contactor.

FIG. 6 is a view, showing the preferred embodiment of the present invention against a touch screen.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

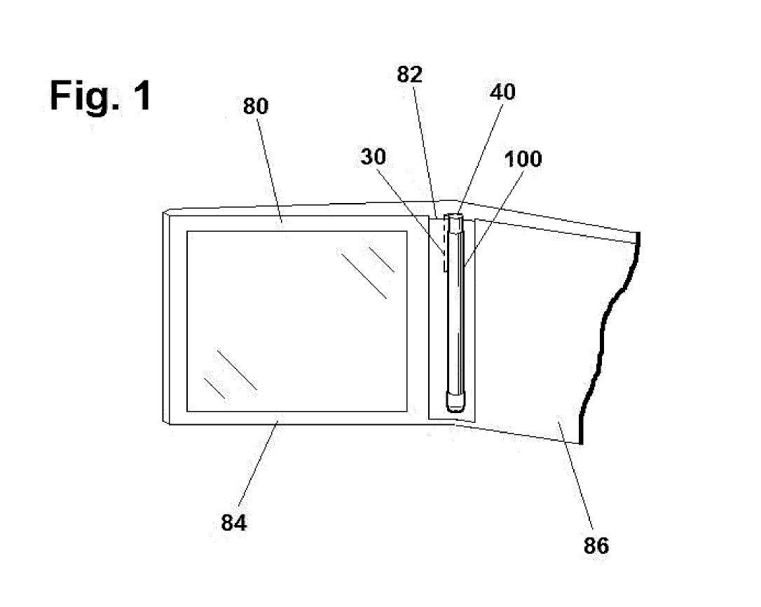

FIG. 1 is a view in perspective showing a wallet and the manner in which the article-touching and writing apparatus is positioned in the hinging fold thereof for available use. As shown in FIG. 1, a retractable refill cartridge 1 in a stowed configuration, so the article-touching and writing apparatus 100 can be transported by clipping to the interior hinge fold 82 in between the half-sections 84 and 86 of a conventional type wallet 80 by a relatively small resilient pocket-clip 30. The pocket clip 30 is preferably formed integral with the actuation cap 40 but they can be separate components secured together.

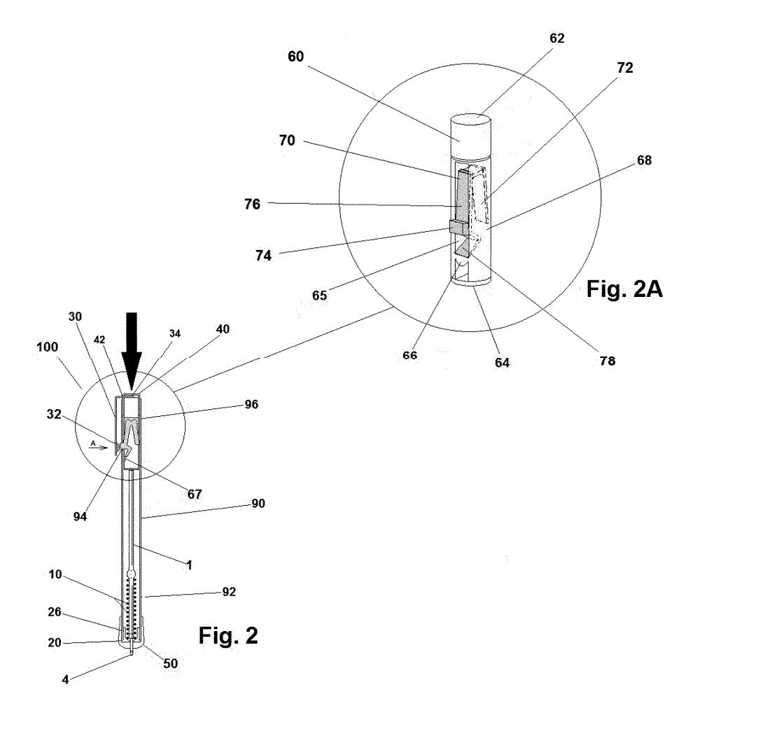

FIG. 2 is a longitudinal sectional view through a retractable pen embodying a preferred form of the invention and illustrating the writing instrument in writing position. FIG. 2A is a greatly enlarged, generally perspective view of the encircled area designated in FIG. 2. As shown in FIGS. 2 and 2A, an article-touching and writing apparatus 100 comprises a body 1, a plunger member 60, a pocket clip 30 with a pocket clip formation 32, which the pocket clip 30 is coupled to the plunger member 60, and a latch spring 70 with a camming projection 74, which the latch spring 70 is mounted in the plunger member 60. The plunger member 60 is positioned within the body 90; and the pocket clip formation 32 is moved and corresponds to the camming projection 74 when the plunger member 60 receives pressure. Moreover, the plunger member 60 further comprises an actuation end 62 coupled to the pocket clip 30, a plunger body 68 having a elongated slot for mounting the latch spring 70, an instrument end 64, a detent 66 with a sloped interior mounted near the instrument end 64.

Additionally, a horizontal slot 42 is formed in the upper end of the actuation cap 40 to embrace the attachment 34 section of the pocket clip 30 and is held in place by a durable adhesive or equivalent. The attachment 34 and actuation cap 40 are mounted on the actuation end 62 of the plunger member 60 and is provided for attaching to the article-touching and writing apparatus 100 to the hinge fold 82 of a conventional type wallet 80. The pocket clip 30 is mounted on the plunger member 60 for shifting movement longitudinally thereof. For this purpose the lower end of the pocket clip 30 is formed to engage the outer surface of the camming projection 74.

The plunger member 60 and the latch spring 70 form a push button which against the helical spring 10. As shown in FIG. 2, the article-touching and writing apparatus 100 comprises a body 90 and a refill cartridge 1 including a pen tip 4; and the refill cartridge 1 and the pen tip 4 is extended out from the body when the plunger member receives the pressure. Specifically, a downward manual pressure against the actuation end 62 will cause the plunger member 60 to slide downwardly within the body 1 and force the refill cartridge 1 until it reaches its writing position. As shown in FIG. 2A, the latching spring 70 further comprises a latching tip 78 which is coupled to one end of the camming projection 74 with an acute angle, a front leg 76 coupled to another end of the camming projection 74; and a back leg 72 coupled to the front leg 76. The latching lip 78 engages the detent 66 when the plunger member 60 receives the pressure. At this time the latching tip 78 will engage the detent 66 of the plunger member 60 to latch the refill cartridge 1 in position and the pocket clip formation 32 will move into engagement position with the camming projection 74 of the latch spring 70.

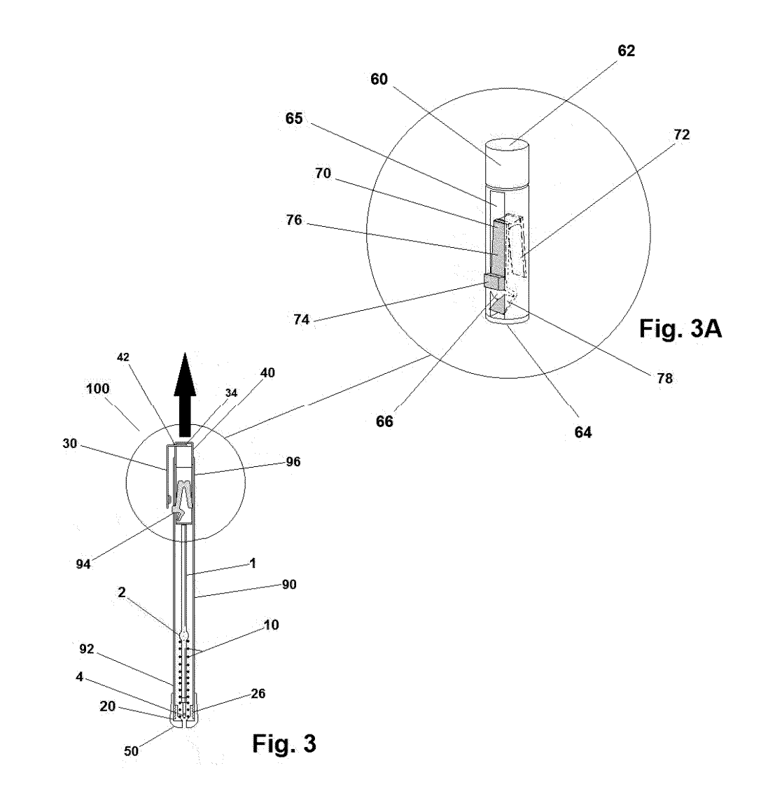

The refill cartridge 1 further comprises an enlargement 2, and the article-touching and writing apparatus 100 further comprises a helical spring 10 surrounding portion of the refill cartridge, a body tip 20, and a contactor 50 slipping on the body tip 20. Specifically, the helical spring 10 is mounted between the enlargement 2 and the body tip 20. The material of the body, the contactor, and body tip are conductive materials. FIG. 2 shows the retractable refill cartridge 1 in a deployed configuration so the article-touching and writing apparatus 100 is to be used to sign sales slips or any other writing purpose. In order to retract the refill cartridge 1 from the position shown in FIG. 2, the pocket clip 30 may be merely manually pressed the section on the lower tip of the pocket clip 30 in the direction of arrow A shown in FIG. 2. During this movement the pocket clip formation 32 engages the camming projection 74 of the latch spring 70, camming the front leg 76 inwardly, whereupon the spring 10 will become effective to retract the refill cartridge 1 and plunger member 60. The refill cartridge 1 is urged rearwardly toward its retracted position shown in FIG. 3 by helical compression spring means 10 which surrounds the forward portion of the refill cartridge 1 and is seated between a shoulder inside the lower end of body tip 20 and the enlargement 2 formed on the refill cartridge 1 midway between its ends.

FIG. 3 is a longitudinal sectional view through a retractable pen embodying a preferred form of the invention and illustrating the writing instrument in retracted position. FIG. 3A is a greatly enlarged, generally perspective view of the area designated in FIG. 3 as 3A. The structure of the article-touching and writing apparatus 100 in FIGS. 3 and 3A is same as the structure disclosed by FIGS. 2 and 2A expect for the pressure direction that the plunger member accepts. As shown in FIG. 3, the refill cartridge 1 is urged into its retracted position by helical compression spring means 10 which surrounds the forward portion of the refill cartridge 1 and is seated between a shoulder inside the lower end of body tip 20 and the enlargement 2 formed on the refill cartridge 1.

As indicated in FIGS. 2 and 3 of the drawings, the plunger member 60 of the article-touching and writing apparatus 100 comprises an elongated substantially cylindrical body 68 having an actuation end 62 and a instrument end 64, with the instrument end 64 and the actuation end 62 being closed to form a push button to be operated by the thumb of a user. The plunger body 68 is formed with two integral beams to form an elongated slot 65. A detent 66 is integrally formed near the instrument end 64 of the plunger member 60 and includes a sloped interior 67. As the plunger body 68 sliding vertically alone the body of the article-touching and writing apparatus, the latch spring 70 disengages and engages with the detent 66 when the refill cartridge 1 is moved between its writing position shown in FIG. 2A and its retracted position shown in FIG. 3A.

The latch spring 70 is mounted against both in the elongated slot 65 and body rear end 96. The back leg 72 of the latch spring 70 engages the inner surface of the body rear end 96. The front leg 76 of the latch spring 70 comprises latch means and camming means and for this purpose has a portion bent over at an acute angle to form a latching tip 78. The latching tip 78 will be positioned right above the detent 66 on the front side of the plunger member 60 when the refill cartridge 1 is in the writing position. A camming projection 74 formed on the front leg 76 above latching tip 78 and extends outwardly to protrude through camming opening 94. The extending and retracting mechanism can be any known mechanism that can be scaled to fit the body 90 and, activated by relative actuation of components.

In order to fit into a conventional sized wallet 80, the greatest outside diameter of the body 90 should not exceed 5 mm. The wall thickness of the body 90 must be limited in order to keep the total diameter approximately 5 mm. Assuming that the refill cartridge 1 diameter will be about 0.125 in diameter, it can be deduced from studying the cross-sectional view of the article-touching and writing apparatus 100 that the wall thickness can only be about 0.016″. No doubt metal tubing material would have to be used in the construction of the body 90 to give sufficient strength with this wall thickness. The length of the article-touching and writing apparatus 100 must also be limited in order to fit inside a conventional sized wallet 80. Test has shown that the greatest length of the article-touching and writing apparatus 100 should not exceed 3⅛″ (78 mm). In the present embodiment, the article-touching and writing apparatus 100 is miniature and designed to fit into a conventional sized wallet 80. However, other variations in length and diameter can be constructed in order to satisfy the need of the end user (e.g., normal sized pen, or the like) or different sizes of wallets or purses.

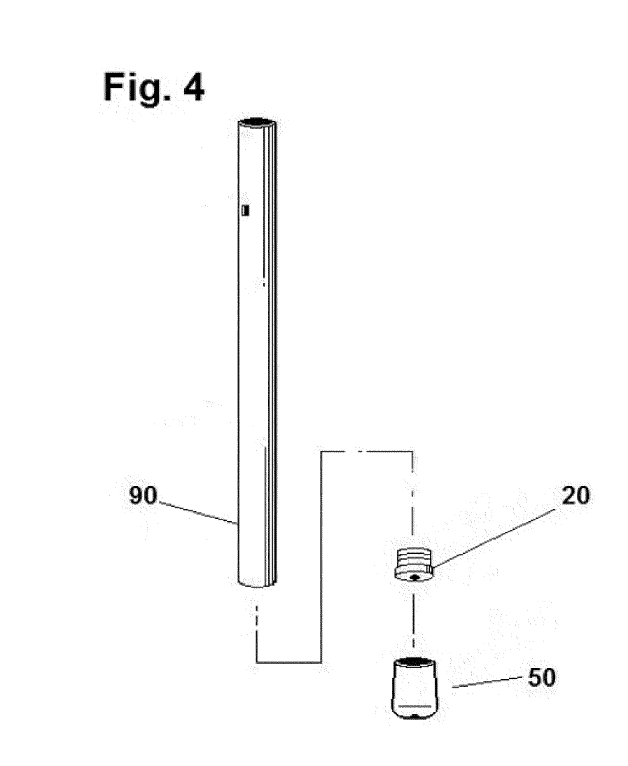

In the present embodiment, the body 90 and the contactor 50 are both conductive, which indicates that the body 90 and the contactor 50 can provide a conductive path with a resistance lower than a resistance of a human body. FIG. 4 shows that body tip 20 is inserted into the forward end of the body 90, and the conductive contactor 50 slips over the body tip 20 and the forward end of the body 90. In addition, for example, the body 90 may be made of a durable conductive material like stainless steel. The removable body tip 20 includes a receiver end 26 to fit into the forward end 92 of the conductive body 90 by a threaded connection or equivalent. The pen tip 4 of a refill cartridge 1 is extended and retracted through the body tip 20 for use and storage, respectively. The body tip 20 may be made of conductive metal or another durable conductive material. The refill cartridge 1 can be replaced by removing the conductive contactor 50, and body tip 20, and then removing a spent refill cartridge 1, inserting a new refill cartridge 1 in its place and reattaching the body tip 20 and conductive contactor 50. The refill cartridge 1 is preferably a ball point pen, or it can be selected from one, or more of the following items, pencil, marker, stylus, highlighter, or equivalent.

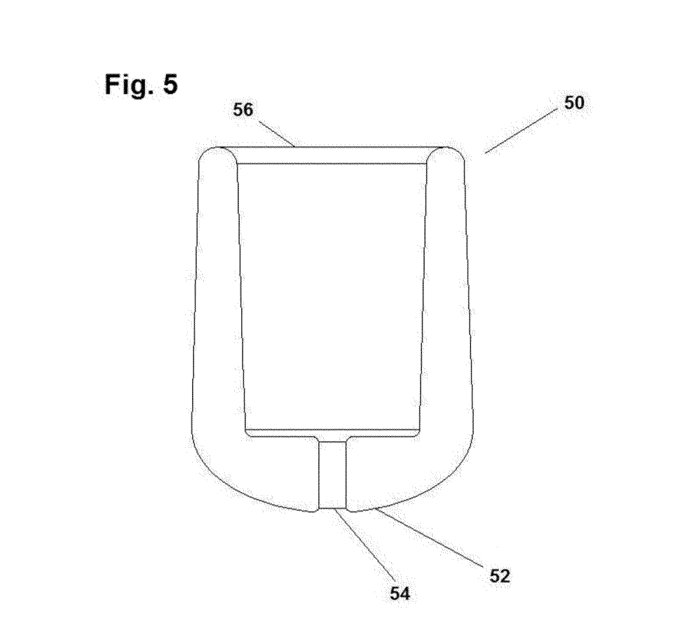

FIG. 5 is detailed sectional view of the conductive contactor. As shown in FIG. 5, the contactor 50 further comprises: a receiving end 56 engaging the body tip 20; and a central opening 54 used for allowing the pen tip 4 to extend and retract for respectively use and storage; and a bridge surface 52 mounted near the central opening 54. Moreover, FIG. 5 further shows a conductive contactor which is specifically configured for use with a capacitive touch screen. A capacitive touch screen presents unique challenges because in order for it to be actuated by a device touching it, the device must be (1) at least somewhat conductive; and (2) able to bridge a distance across the capacitive touch screen. The conductivity must be at least comparable to human skin (though it can be greater). The term “conductive” in this context should be understood to mean a conductivity at least as great as the conductivity of human skin under poor conditions. The distance to be bridged ranges from a minimum of about 2 mm to a maximum of about 20 mm. In other words, a single point of contact will not work.

Of course, one goal of the alternative embodiment of the present invention is to provide rapid actuation of a capacitive touch screen. A rigid, planar contacting device will not work well for this, since the user would have to carefully align the plane of the contacting device with the plane of the touch screen. This cannot be done rapidly. In fact, the human finger tip provides a good model for the type of contacting device needed. The human finger tip is (1) at least mildly conductive; and (2) sufficiently pliable to flatten across a sufficient distance when pressed against a capacitive touch screen. The human finger tip essentially creates a conductive bridge from one portion of a touch screen to the other. The touch screen senses the presence of this conductive bridge and this fact allows the user to interact with the touch screen.

FIG. 5 shows the conductive contactor 50 with a central opening 54 to allow the pen tip 4 of a refill cartridge 1 to extend and retract for use and storage, respectively. The conductive contactor 50 also includes a receiver end 56 that slips over and engages the body tip 20 and body forward end 92. A frictional engagement may be sufficient to hold the conductive contactor 50 in place, though in some cases it is preferable to add a conductive adhesive.

The present invention focuses on the ability of the article-touching and writing apparatus 100 to create a conductive connection between the user's fingers and the touch-screen device 110.

FIG. 5 shows one embodiment of the present invention. In this embodiment of the present invention article writing apparatus conductive contactor 50 is made of a pliable and conductive material. As an example, PolyOne Corporation, of Cleveland, Ohio, creates a line of materials called Stat-Tech® Electrically Conductive Compounds, which are specifically engineered to allow low-to-high levels of conductivity. It is desirable for the conductive contactor 50 to have some degree of elasticity, therefore the Elastomeric Stat-Tech compounds, from the Stat-Tech® rigid resin family would be preferred.

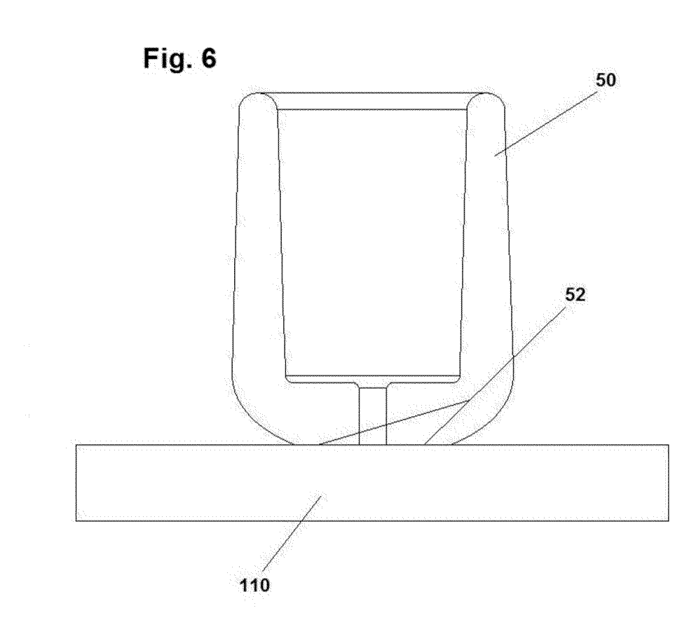

In order for bridge surface 52 of conductive contactor 50 to effectively bridge the connection between the touch-screen device 110 and the user's fingers, bridge surface 52 of conductive contactor 50 must have a diameter between 2 mm and 20 mm, having a preferable diameter of 5 mm. FIG. 5 shows bridge surface 52 as a slightly rounded surface. As described above, conductive contactor 50 should be made of a softer, resilient material that deforms as it is pressed against touch screen 110 in order to flatten across a sufficient distance when pressed against a capacitive touch screen 110, In order to create a conductive connection between touch-screen 110 and the user's fingers. FIG. 6 illustrates the deformable nature of conductive contactor 50 as user presses down against touch-screen 110.

In the present embodiment of the invention the conductive contactor 50 accepts charge from the touch-screen 110 at a particular point on the touch-screen 110 and transmits the charge through the conductive contactor 50, and body 90 to the user's fingers. The change in charge on the surface of the touch-screen 110 at a particular point along the touch-screen's grid is sensed by the touch-screen device 110 thereby allowing the device to respond.

The material of conductive contactor 50 may be selected to allow a user holding the article-touching and writing apparatus 100 to operate the input mechanism of an electronic device. The input mechanism of the electronic device can take a variety of forms such as, for example, buttons, or capacitive touch screen, or resistive touch screen. The material of the conductive contactor 50 may also be selected to keep the input mechanism free of scratches, smudges and grease. The conductive contactor 50 can be replaced by removing the spent conductive contactor 50, and then, attaching a conductive contactor 50 in its place.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An article-touching and writing apparatus, comprising:
a body with a rear end and a forward end;
a plunger member placed within the said body at said rear end;
a latch spring, mounted within said plunger member, having a camming projection;
a cartridge placed within said body and underneath said plunger member; and
a contactor attached on said body at said forward end for article-touching;
wherein said cartridge is extended out from said body at said second end for writing when said plunger member receives a pressure.

2. The article-touching and writing apparatus as claimed in claim 1, further comprises:
a pocket clip, coupled to said plunger member, including a packet clip formation, wherein said pocket clip formation corresponds to said camming projection when said plunger member receives said pressure.

3. The article-touching and writing apparatus as claimed in claim 2, wherein said plunger member further comprises:
an actuation end, coupled to the pocket clip;
an instrument end;
a plunger body, having an elongated slot for mounting said latch spring; and
a detent, having a sloped interior, mounted near the instrument end;
wherein the actuation end and the instrument end are closed to form a push button.

4. The article-touching and writing apparatus as claimed in claim 2, wherein said plunger member further comprises a detent; and said latch spring further comprises:
a latching tip, coupled to one end of said camming projection, having an acute angle;
a front leg, coupled to another end of said camming projection; and
a back leg, coupled to said front leg;
wherein said latching lip engages to said detent when said plunger member receives said pressure.

5. The article-touching and writing apparatus as claimed in claim 4, wherein said cartridge is retracted into said body when said pocket clip formation is pushed against said camming projection.

6. The article-touching and writing apparatus as claimed in claim 1, wherein said cartridge is a refill cartridge.

7. The article-touching and writing apparatus as claimed in claim 1, wherein said cartridge further comprises an enlargement and a pen tip.

8. The article-touching and writing apparatus as claimed in claim 7, wherein said body further comprises:
a helical spring surrounding said cartridge, wherein said helical spring is positioned between said enlargement and said pen tip.

9. The article-touching and writing apparatus as claimed in claim 1, wherein said body and said contactor are made of conductive materials.

10. The article-touching and writing apparatus as claimed in claim 1, further comprises a body tip, wherein said body tip has a thread to thread into said forward end of said body, and said contactor slips over said body tip and said forward end.

11. A method for providing an apparatus for article-touching and writing, comprising:
providing a body with a rear end and a forward end;
placing a plunger member within the said body at said rear end;
mounting a latch spring with a camming projection within said plunger member;
placing a cartridge within said body and underneath said plunger member;
attaching a contactor on said body at said forward end;
extending said cartridge out from said body at said second end for writing by pressing said plunger member; and
retracting said cartridge into said body and performing article-touch with said contactor.

12. The method for providing an apparatus for article-touching and writing as claimed in claim 11, further comprises:
mounting a pocket clip including a packet clip formation onto said plunger member; and
pressing said plunger member such that said pocket clip formation corresponds to said camming projection.

13. The method for providing an apparatus for article-touching and writing as claimed in claim 12, further comprises:
providing an elongated slot on said plunger member for mounting said latch spring;
providing a detent with a sloped interior; and
pushing said plunger member as a push button.

14. The method for providing an apparatus for article-touching and writing as claimed in claim 12, further comprises:
providing a detent in said plunger member;
providing a latching tip with an acute angle coupled to one end of said camming projection; and
pushing said plunger member such that said latching lip engages to said detent.

15. The method for providing an apparatus for article-touching and writing as claimed in claim 14, further comprises:
pushing said pocket clip formation against said camming projection to retract said cartridge into said body.

16. The method for providing an apparatus for article-touching and writing as claimed in claim 11, further comprises:
providing a refill cartridge as said cartridge.

17. The method for providing an apparatus for article-touching and writing as claimed in claim 11, further comprises:
providing an enlargement and a pen tip on said cartridge.

18. The method for providing an apparatus for article-touching and writing as claimed in claim 17, further comprises:
placing a helical spring surrounding said cartridge between said enlargement and said pen tip.

19. The method for providing an apparatus for article-touching and writing as claimed in claim 11, further comprises:
providing said body and said contactor made of conductive material.

20. The method for providing an apparatus for article-touching and writing as claimed in claim 11, further comprises:
threading a body tip into said forward end of said body before slipping said contactor over said body tip and said forward end.
